(19) United States
(12) Patent Application Publication
(10) Pub. No.: US 2011/0091620 A1
(43) Pub. Date: Apr. 21, 2011

(54) Apparatus and Method for Perforation of Fruits and Vegetables

(76) Inventor: Jung Hoon HAN, Frisco, TX (US)

(21) Appl. No.: 12/581,983

(22) Filed: Oct. 20, 2009

(51) Int. Cl. A23L 1/212; A23B 4/03; A47J 43/00; B31B 1/25

(52) U.S. Cl. 426/456; 99/537; 83/886

(57) ABSTRACT

An apparatus and method for the perforation of the skins or hulls of food pieces to more efficiently produce a dried, shelf-stable product. The apparatus contains two parallel and adjacent blade wheels positioned longitudinally within a frame in substantially the same horizontal plane at a distance from each other such that the blades' teeth contact product passing between the blade wheels and make perforations. Each blade wheel comprises a plurality of circular blades with a plurality of teeth around the circumference mounted on a rotatable shaft. In one aspect, a guard is provided for each blade wheel to ensure that no product remains on the blades after perforation. The shape, size and number of blades and the distance between the blade wheels may be modified with respect to the size and shape of the product and the strength of the product's skin or hull.

### BACKGROUND OF THE INVENTION

1. Technical Field

The present invention relates to an apparatus and method for the perforation of the skins or hulls of whole fruits, vegetables, grains or legumes to achieve more efficient infusion and dehydration.

2. Description of Related Art

In recent years, consumer demand has been dramatically increasing for healthy foods in general, and healthy snack foods in particular. Healthy snack foods can, for example, take the form of dehydrated slices or cubes of whole fruits or vegetables. The fruit and vegetable pieces (“pieces”) are typically dehydrated through drying, frying and baking. Two advanced dehydration technologies, as examples, are vacuum drying and vacuum frying as conventional air drying and frying yield snacks with an undesirable appearance and higher oil content than desired.

Infusion of the fruit and vegetable pieces prior to dehydration is essential to the dehydration process to achieve the desired product characteristics. Dehydration without prior infusion results in shrinkage of the pieces and an unacceptable texture for sale to consumers. These issues may be resolved by infusing the fruit and vegetable pieces prior to dehydration. Infusion of the fruit and vegetable pieces with a solution containing mono-, di-, or oligo-saccharides, fruit juices, or vegetable fibers adds solids to the fruit and vegetable pieces, which builds the body structure of the pieces and prevents collapse during dehydration. The resulting product is crunchy, has acceptable oil content and retains the appearance of the original fruit and vegetable pieces.

During infusion, solids are infused into fruit and vegetable pieces by immersing them in a hypertonic solution, i.e., a solution with a higher concentration of solids than in the fruit or vegetable. This concentration difference results in two mutually counter flows—solids from the infusion solution entering the fruit or vegetable tissue (solids infusion) and water traveling out of the fruit or vegetable tissue (osmotic dehydration). Subsequent dehydration removes water remaining in the fruit or vegetable tissues after osmotic dehydration. Many different methods for the infusion and dehydration of fruits and vegetables are known in the art.

Infusion and dehydration of whole fruits and vegetables, as compared to slices or cubes (i.e., pieces), is more difficult due to their skins or hulls. The skin or hull acts as a barrier during infusion and dehydration and extends the processing times. The skin or hull also creates explosion problems when the fruit or vegetable is subjected to high-energy or short-time thermal treatments such as boiling, frying, microwave drying as well as high-vacuum treatment such as vacuum drying. Thus, it is desirable to perforate the skin or hull of the whole fruit or vegetable to more efficiently infuse and dehydrate the fruit or vegetable and reduce the processing time, cost, energy requirement and product explosion. It is also desirable that the fruit or vegetable retain its basic shape after being perforated and during both osmotic dehydration and thermal drying.

### SUMMARY OF THE INVENTION

The present invention provides an apparatus and method for the perforation of the skins or hulls of foods (“product”) to more efficiently produce a dried, shelf-stable product. More specifically, the present invention involves forming micrometer to millimeter sized holes in the skin or hull of a fruit or vegetable to more efficiently product a whole, dried fruit or vegetable with modified texture, taste and flavor.

In a preferred embodiment, the perforator comprises two parallel and adjacent blade wheels positioned longitudinally within a frame in substantially the same horizontal plane. Each blade wheel comprises a plurality of circular blades with a plurality of teeth around the circumference of the blade mounted on a rotatable shaft. The blade wheels are positioned at a distance from each other such that the blades' teeth contact product passing between the blade wheels and make perforations. In one aspect, a guard is provided for each blade wheel to ensure that no product remains on the blades after perforation.

The perforator may be adjusted for the specific product to be perforated. The shape, size and number of blades and the distance between the blade wheels may be modified with respect to the size and shape of the product and the strength of the product's skin or hull.

A preferred embodiment of the method of the present invention comprises the steps of introducing product into a perforator having at least one blade wheel, perforating the product with the blade wheel, removing the perforated product from the perforator, immersing the perforated product in an infusion solution for the period until desirable amounts of solids are infused, and dehydrating the infused product to a moisture content of less than the critical moisture content that is described in quality control documents or specification. Crystalline sugar solutions are preferred for infusion in order to produce a product with a crunchy texture, while non-crystalline sugar solutions are preferred to obtain a chewy texture.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a partial top perspective view of an embodiment of Applicant's invention;

FIG. 2 is an end view of an embodiment of Applicant's invention;

FIGS. 3A and 3B are plan views of blades employed in Applicant's invention;

FIG. 4 is a perspective view of a guard employed in Applicant's invention;

FIG. 5 is a partial top perspective view of an embodiment of Applicant's invention;

FIG. 6 is a partial top perspective view of an embodiment of Applicant's invention; and

FIG. 7 is a graph illustrating the results obtained by Applicant's invention.

### DETAILED DESCRIPTION

With reference to the accompanying drawings, identical reference numerals will be used to identify identical elements throughout all of the drawings. In the absence of an indication to a specific figure, refer to FIG. 2.

The present invention involves an apparatus and a method for the perforation of the skins or hulls of foods (“product”) to more efficiently produce a dried, shelf-stable product. As used herein, perforation means forming micrometer to millimeter size holes in the skin or hull of a food without damaging its shape or structure.

The foods used in this invention may be any fruit, vegetable, grain or legume. The product may be fresh or frozen. Examples of fruit that may be used are cranberries, grapes, blueberries, cherries, strawberries, goji berries, Saskatoon berries, olives, and acai. Examples of vegetables that may be used are cherry tomatoes, bell peppers, chili peppers, tomatillos, carrots, and mushrooms. Grains that may be used are corn kernels, sorghums, rices, wheats, barleys, and oats. Legumes that may be used are beans, peas, garbanzos, lentils, and says.

Specifically, the present invention aids in the formation of whole, dried fruits and vegetables with a crunchy texture. Two critical steps in the formation of dried fruits and vegetables are infusion and drying. Perforation of the product facilitates both the infusion and drying processes. The skin or hull of fruits and vegetables is generally resistant to infusion, but perforation creates channels for the penetration of solids and water removal, thus increasing the rate of infusion. Further, perforation evens out the pressure in the product during drying and allows steam or pressurized moisture to escape the product without rupturing the skin or causing blistering. For example, a non-perforated blueberry bursts when subjected to vacuum dehydration. However, perforation of the blueberry's skin prevents bursting and allows the whole blueberry to be dried under vacuum while its shape and structure are maintained.

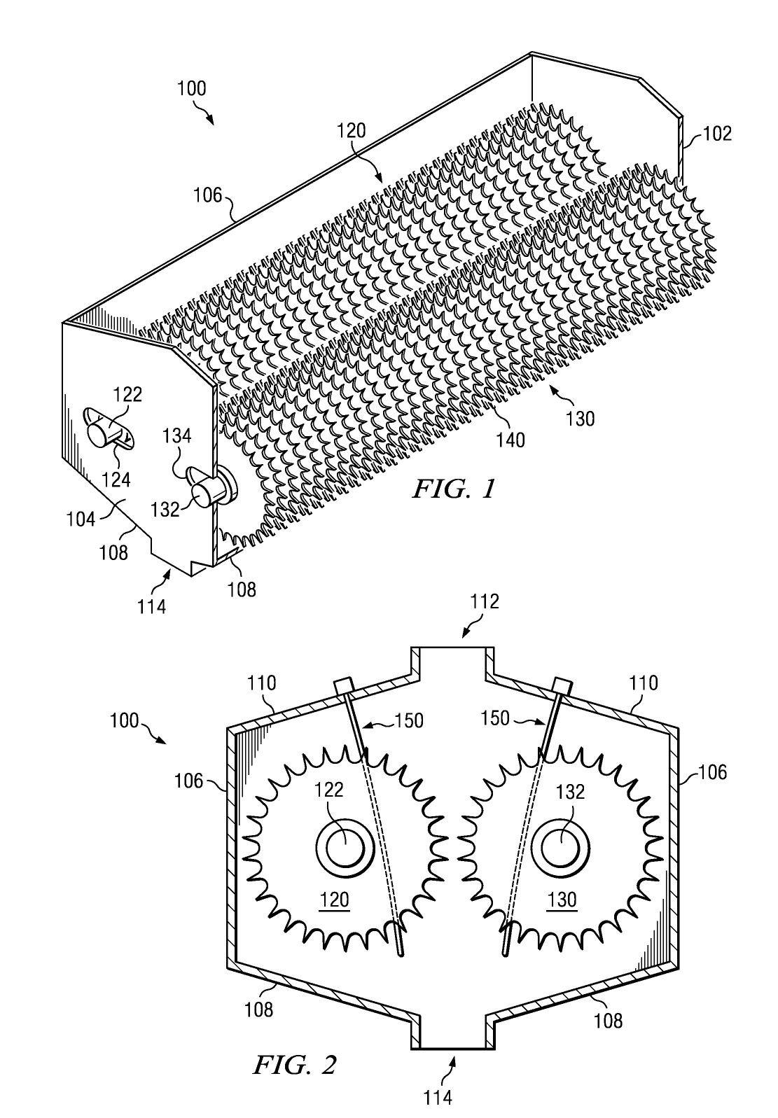

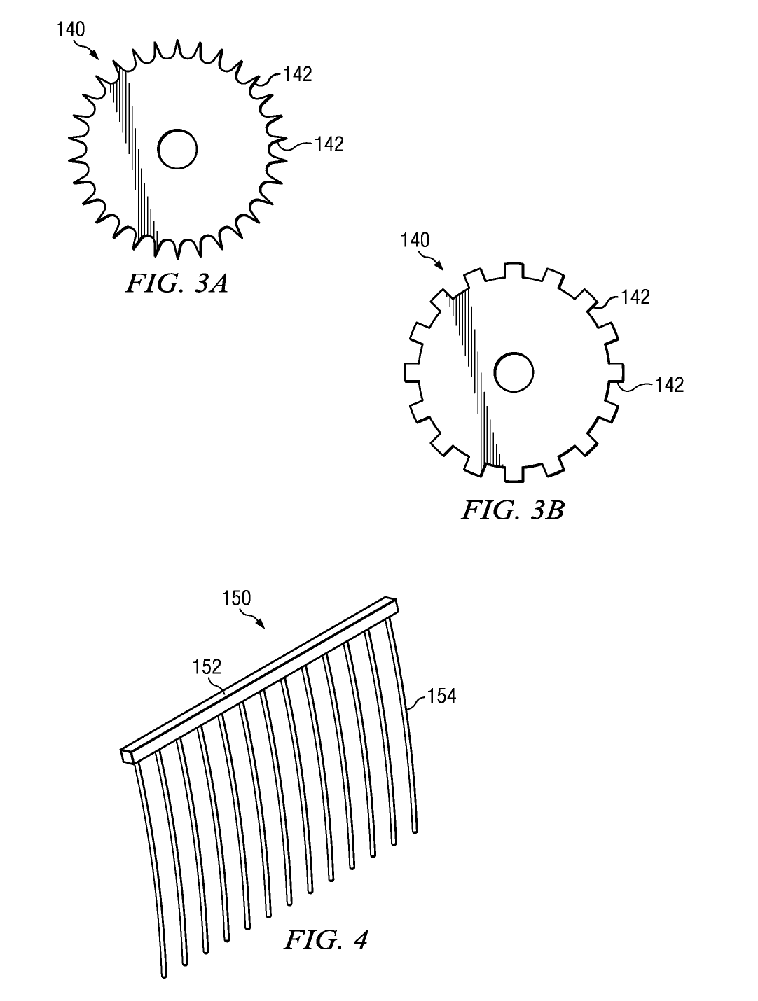

Preferred embodiments of the invention are shown in FIGS. 1 and 2. The perforator 100 contains two parallel and adjacent blade wheels 120, 130 in a longitudinal position within a frame 102. The blade wheels 120, 130 each comprise a rotatable shaft 122, 132, respectively, and a plurality of circular blades 140 mounted on the shafts 122, 132. Each end of the shafts 122, 132 is supported by the frame 102 in substantially the same horizontal plane. The blades 140 are substantially equally spaced along the entire length of the shafts 122, 132. The total number of blades mounted on each shaft 122, 132 ranges from 24 to 192 per foot of shaft, which corresponds to 0.5 to 0.0625 inches between each blade. Referring to FIG. 3, each blade 140 has a plurality of teeth 142 around its circumference which contact the product and make perforations in the product's skin or hull.

The shafts 122, 132 are connected to a motor (not shown) that supplies power to rotate the blade wheels 120, 130. The blade wheels 120, 130 rotate in opposing directions. Referring to FIG. 2, a first blade wheel 120 rotates in a clockwise direction, while a second blade wheel 130 rotates in a counter-clockwise direction. Thus, product that is introduced into the perforator 100 will be directed between the blade wheels 120, 130 to be perforated by the blades 140.

In one embodiment, shown in FIG. 1, the frame 102 is partially open with two opposed end walls 104, two parallel side walls 106 connected orthogonally to the end walls 104, and two bottom walls 108 connected to the end walls 104 and side walls 106. The shafts 122, 132 of the blade wheels 120, 130 are supported by the end walls 104. The side walls 106 are at least as high as the top of the blade wheels 120, 130 to ensure that all product remains within the perforator 100 during perforation. The bottom walls 108 slope downward and inward from the side walls 106 at an obtuse angle towards the center of the frame 102. At the proximate junction of the bottom walls 108 is an opening 114 for the removal of perforated product.

In an alternate embodiment, shown in FIG. 2, the frame 102 further comprises top watts 110 connected to the end walls 104 and side walls 106 to form an enclosure. The top walls 110 slope upward and inward from the side walls 106 at an obtuse angle toward the center of the frame 102. In a preferred embodiment, an opening 112 for the introduction of product into the perforator 100 is at the proximate junction of the top walls 110. The opening 112 can be positioned anywhere in the top walls 110 or at the junction of the top wall 110 and side wall 106. The size of the opening 112 can vary from a slit stretching the length of the enclosure 102 to a small hole. In determining the size of the opening 112, the size of the product to be perforated must be considered. Using an enclosed frame 102 is preferable as it allows a greater volume of product to be introduced into the perforator 100 at a time and ensures that all product remains within the perforator 100 during perforation.

In a preferred embodiment, two guards, one for each blade wheel, are used to ensure that no product remains on the blades 140 after perforation. Referring to FIG. 4, the guards 150 resemble a comb with a support bar 152 and a plurality of tines 154 attached to the support bar 152. Referring now to FIG. 2, the guards 150 are inserted into a slit in the top walls 110 such that the support bar 152 rests on the top wall 110 and the tines 154 extend downward through the blade wheels 120, 130. The support bars 152 of the guards 150 are substantially the same length as the blade wheels 120, 130 and contain substantially the same number of tines 154 as blades 140. Each tine 154 rests on the shafts 122, 132 between each blade 140 and extends below the blade wheels 120, 130. As the blade wheels 120, 130 rotate, any product remaining on the blades 140 comes into contact with the tines 154 and is removed from the blades 140. In alternative embodiments, the guards 150 can be supported by the side walls 106 and the tines 154 extend through the blades 140 to substantially the same position as shown in FIG. 2 or a position closer to the side walls 106. The guards 150 can also be a solid member mounted on the side walls 106 or the bottom walls 108 in proximity to, but not in contact with, the blades wheels 120, 130 such that any product remaining on the blades 140 contacts the guards 150 and is removed.

The size, shape and number of the blades 140 forming the blade wheels 120, 130 may be modified with respect to the size and shape of the product and the strength of the product's skin or hull. First, the shape of the blades 140 may be changed to adjust the size of the perforation. Product with a thin, weak skin or hull only requires a small hole to sufficiently promote infusion and drying, while product with a thicker, tougher skin or hull requires a larger perforation to achieve the same result. For example, the skin of blueberries is thin, so a 0.5 to 2 millimeter hole is sufficient. The preferred size of holes for blueberries is 1 millimeter. In contrast, cranberries have a thick, tough hull and require a 1 millimeter to 0.25 inch hole. The preferred size of holes for cranberries is 2 millimeter. Referring to FIG. 3A, a blade 140 with pointed teeth 142 may be utilized to make a small circular-shaped perforation on the product's skin or hull. When a larger slit-like perforation is desired, a blade 140 with squared teeth 142, shown in FIG. 3B, may be used.

Second, the number of blades 140 mounted on the shafts 122, 132 may be modified according to the size of the product to be perforated. When the product to be perforated is large, such as strawberries, the number of blades needed is less than when the product is small, such as blueberries. For example, 4 blades mounted per 1 inch is preferred for the perforation of strawberries while 8 blades mounted per 1 inch from each other is preferred for the perforation of blueberries.

Further, the horizontal distance between the shafts 122, 132 and thereby blade wheels 120, 130 may be adjusted to accommodate products of different sizes and control the depth of the perforations. Smaller product, such as blueberries, requires the blade wheels to be in closer proximity to perforate the product than larger product like strawberries. Also, products with a thick skin or hull or a tough internal structure, such as cranberries, require a deeper penetration to achieve efficient infusion. Thus, the horizontal distance between the blade wheels 120, 130 may be decreased so that the blades' teeth penetrate deep into the product. In a preferred embodiment, the shafts 122, 132 are supported by the end walls 104 in slots 124, 134, respectively. The shafts 122, 132 may be moved horizontally within the slots 124, 134, thus increasing or decreasing the horizontal distance between the blade wheels 120, 130. A locking mechanism (not shown) is used to keep the shafts 122, 132 in position.

The perforator 100 is preferably used as part of a continuous process. A conveyor may be used to deliver the product from an earlier processing step to the opening 112. The product then passes between the rotating blade wheels 120, 130 where it is perforated. The product exits the perforator 100 through the opening 114, where a conveyor may be used to deliver the perforated product for further processing, such as infusion and drying.

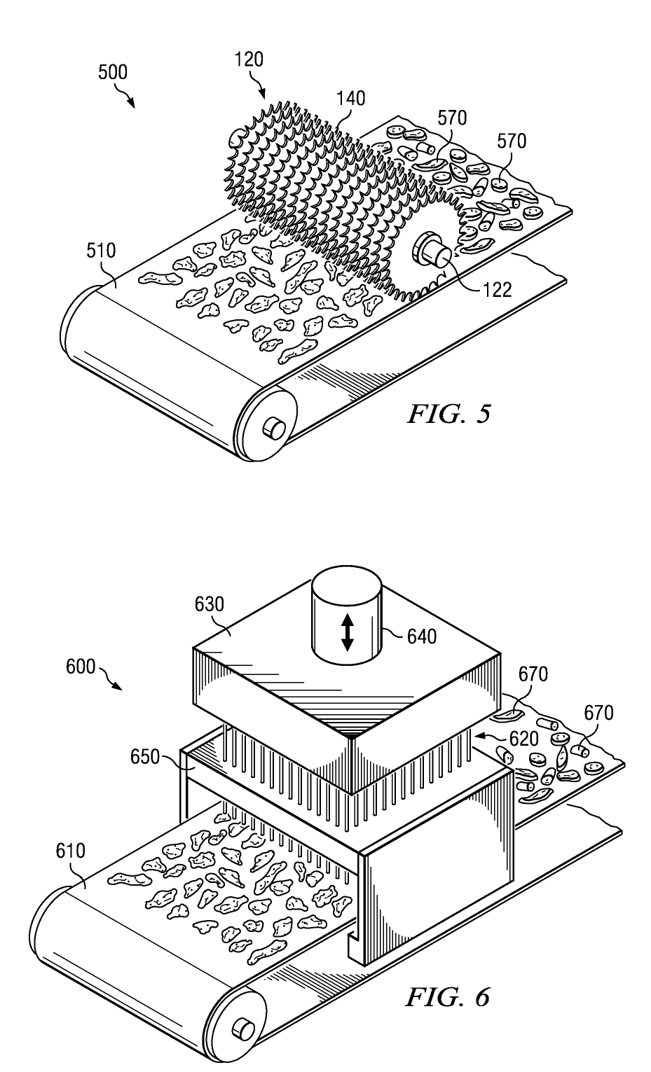

An alternate embodiment of the invention is shown in FIG. 5. This embodiment comprises a single blade wheel 120 positioned longitudinally above a conveyor 510 at a distance of 0.0625 to 1 inches such that the blade wheel 120 contacts product 570 moving along the conveyor 510. The blade wheel 120 is substantially the same width as the conveyor 510. Each end of the rotatable shaft 122 is supported by a frame (not shown) and is connected to a motor (not shown) which provides power for the shaft's rotation. The blade wheel 120 is rotated in the opposite direction of the conveyor 510 when viewed from above. The vertical distance of the blade wheel 120 from the conveyor 510 may be adjusted to accommodate products of different sizes and control the depth of the perforations. A guard (not shown) may be used to ensure that no product remains on the blades 140 after perforation.

The double blade wheel embodiment shown in FIGS. 1 and 2 is preferred to the single blade wheel embodiment shown in FIG. 5. The single blade wheel embodiment only perforates product on one side, while the double blade wheel perforates product on two sides. Thus, product perforated by the double blade wheel embodiment contains more perforations, which results in faster, more efficient infusion and drying. However, the single wheel embodiment also has its advantages. Because product remains on the conveyor and is not transferred for the perforating operation, the single wheel embodiment is faster and preferred for more delicate product.

Another alternate embodiment of the invention is shown in FIG. 6. In this embodiment, a needle block 600 is positioned above a conveyor 610. A plurality of needles 620, ranging from 4 to 64 needles, are mounted on a block 630. The block 630 is the same width as the conveyor 610 and is at least 4 inches long in the conveying direction. The block 630 is attached to a driving mechanism 640 that moves the needle block 600 upward and downward above the conveyor 610 such that the needles 620 contact and make perforations in the product 670 being transported by the conveyor 610. The speed and frequency at which the needle block 600 is lowered toward the conveyor 610 is adjustable based on the flow, size and volume of the product 670. The needles 620 extend through a stationary guard 650, which ensures that all product is removed from the needles after perforation and provides added stability for the needles 620.

A preferred embodiment of the method of the present invention comprises the steps of introducing product into a perforator having at least one blade wheel 120, perforating the product with the blade wheel 120, removing the perforated product from the perforator, immersing the perforated product in an infusion solution, and dehydrating the infused product. The single blade wheel perforator 500 or the double blade wheel perforator 100 may be used. The perforator forms 0.5 micrometer to 0.25 inch sized holes in the skin or hull of the product during the perforating step.

The perforated product remains immersed in the infusion solution for at least 10 minutes. Crystalline sugar solutions are preferred for infusion to create a crunchy texture, while liquid sugar solutions are preferred to create a chewy texture. Examples of crystalline sugars that may be used are sucrose, glucose, maltose, fructose, lactose or any sugar in a crystalline or powder form at room temperature. Examples of liquid sugars that may be used are high fructose corn syrup and high-maltose rice syrup.

Dehydration of the product may be accomplished by a vacuum dryer, vacuum microwave, fluidized bed dryer, convectional air dryer, or puffing dryer. The product is dehydrated to a moisture content of less than 10% to obtain a shelf-stable product. If a half-product, or intermediate moisture food, is desired, a moisture content of less than 40% is sufficient.

### EXAMPLE

The perforator 100 was set up to perforate cranberries. Blades 140 with pointed teeth 142, such as that shown in FIG. 3A, a total of 96 blades 140 were mounted on the 2 feet-long shafts 122, 132 (48 blades per foot) at a distance of 0.25 inch apart to form the blade wheels 120, 130. The horizontal distance between the blade wheels 120, 130 was adjusted to be 0.125 inch. The blade wheels 120, 130 were rotated at a speed of 60 rpm.

100 grams of frozen cranberries were introduced into the perforator 100 via the opening 112. The cranberries proceeded through the blade wheels 120, 130 where they were perforated. The product then exited the perforator 100 via the opening 114.

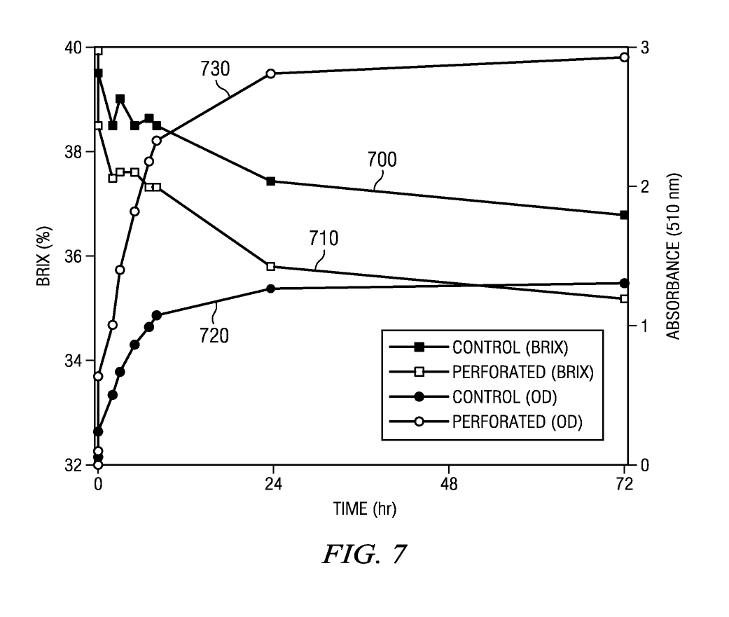

100 grams of perforated cranberries and 100 grams of non-perforated cranberries (control) were immerged into separate vessels, each containing 1 kilogram of 40% (w/w) sucrose solution. With slow agitation at room temperature, the infusion solution was sampled and their sugar content (Brix) and cranberry juice color (absorbance or OD at 510 nm) were monitored over a 72-hour period. The Brix was measured using a digital reflectometer and absorbance (or OD) was determined by a spectrophotometer at 510 nm. FIG. 7 compares the data obtained on the change in sugar concentration and color of the infusion solution for the perforated and non-perforated cranberries over the 72-hour period. The time elapsed (in hours) is shown on the x-axis. The concentration, in Brix (%), of the infusion solution is shown on the left y-axis and the absorbance of the infusion solution is shown on the right y-axis.

Referring to FIG. 7, the square data points indicate the concentration levels of the infusion solution at various time intervals. Line 700 represents the change in concentration of the infusion solution containing the non-perforated cranberries and line 710 represents the change in concentration of infusion solution containing the perforated cranberries. At approximately 6 hours, the concentration of the non-perforated cranberries' infusion solution was approximately 38.7% Brix, while the concentration of the perforated cranberries' infusion solution was approximately 37.3% Brix. At about 24 hours, the concentration of the non-perforated cranberries' infusion solution was approximately 37.5% Brix, while the concentration of the perforated cranberries' infusion solution was approximately 35.8% Brix. The 1.7% difference in 1 kilogram of infusion sugar concentration equates to 17 grams more of solids being absorbed by the perforated cranberries.

Still referring to FIG. 7, the circle data points indicate the absorbance (OD) of the infusion solution at various time intervals. Line 720 represents the change in absorbance (OD) of the infusion solution containing the non-perforated cranberries and line 730 represents the change in absorbance (OD) of the infusion solution containing the perforated cranberries. At approximately 6 hours, the absorbance (OD) of the non-perforated cranberries' infusion solution was approximately 1, while the absorbance of the perforated cranberries' infusion solution was approximately 1.8. At about 24 hours, the absorbance of the non-perforated cranberries' infusion solution was approximately 1.2, while the absorbance of the perforated cranberries' infusion solution was approximately 2.8. A higher absorbance (OD) value at 510 nm corresponds to a solution with a darker red color, which means more cranberry juice had been extracted.

It can be seen that the perforated cranberries absorbed more sucrose and, consequently, the concentration of the infusion solution of the perforated cranberries was lower than that of the non-perforated cranberries. The infusion solution with perforated cranberries was much stronger in red color than that of the infusion solution of the non-perforated cranberries as shown by the higher absorbance of the perforated cranberries' infusion solution. Thus, perforation of the cranberries greatly increased the rate of infusion.

The above described invention discloses a method and preferred embodiments of an apparatus for the perforation of the skins or hulls of food pieces. Although the invention has been particularly shown and described, the disclosure is not intended to limit the scope of the invention. It will be understood by those skilled in the art that various changes in form and conditions may be made therein without departing from the spirit and scope of the invention.

What is claimed is:

1. An apparatus for perforating food pieces comprising:
An enclosure having two opposed end walls;
Two blade wheels each having two ends positioned longitudinally within said enclosure, wherein each end of said blade wheels is supported by said end walls of said enclosure in substantially the same horizontal plane;
An opening for the introduction of food pieces at the top of said enclosure; and
An opening for the removal of said food pieces at the bottom of said enclosure.

2. The apparatus of claim 1 wherein each said blade wheel comprises a rotatable shaft and a plurality of circular blades mounted on said shaft.

3. The apparatus of claim 2 wherein each of said blades comprise a plurality of teeth around the circumference of said blades.

4. The apparatus of claim 3 wherein said teeth are pointed.

5. The apparatus of claim 3 wherein said teeth are squared.

6. The apparatus of claim 1 wherein the horizontal distance between said blade wheels is adjustable.

7. The apparatus of claim 1 wherein said enclosure further comprises two parallel side walls connected orthogonally to said end walls, two bottom walls connected to said end walls and said side walls, wherein said bottom walls slope downward and inward from said side walls at an obtuse angle, and two top wails connected to said end walls and said side walls, wherein said top walls slope upward and inward from said side walls at an obtuse angle.

8. The apparatus of claim 7 wherein said opening for the removal of said food pieces is at the proximate junction of said bottom walls.

9. The apparatus of claim 7 wherein said opening for the introduction of said food pieces is at the proximate junction of said top walls.

10. The apparatus of claim 7 further comprising two guards having a plurality of tines attached to a support bar, wherein said guards are supported by said enclosure and positioned such that said tines extend between each said blade.

11. The apparatus of claim 1 wherein said blades are substantially equally spaced along said shaft and are mounted on said shafts at a distance of 0.0625 to 1 inches from each other.

12. An apparatus for the perforation of food pieces comprising:
A frame having two opposed end walls and two parallel side walls connected orthogonally to said end walls;
A first rotatable shaft having two ends positioned longitudinally within said frame, wherein each end of said first shaft is supported by said end walls of said frame;
A second rotatable shaft having two ends, wherein said second shaft is parallel and adjacent to said first shaft within said frame, wherein further each end of said second shaft is supported by said end walls in said frame in substantially the same horizontal plane as said first shaft; and
A plurality of circular blades mounted on said first shaft and said second shaft.

13. The apparatus of claim 12 wherein said blades further comprise a plurality of teeth around the circumference of said blades.

14. The apparatus of claim 13 wherein said teeth are pointed.

15. The apparatus of claim 13 wherein said teeth are squared.

16. The apparatus of claim 12 wherein the horizontal distance between said shafts is adjustable.

17. The apparatus of claim 12 wherein said frame further comprises two bottom walls connected to said end walls and said side walls, wherein said bottom walls slope downward and inward from said side walls at an obtuse angle.

18. The apparatus of claim 17 wherein said bottom walls form an opening at their proximate junction for the removal of said food pieces.

19. The apparatus of claim 18 wherein said frame further comprises two top walls connected to said end walls and said side walls, wherein said top walls slope upward and inward from said side walls at an obtuse angle to form an enclosure.

20. The apparatus of claim 19 wherein said top walls form an opening at their proximate junction for the introduction of said food pieces.

21. The apparatus of claim 19 further comprising two guards having a plurality of tines attached to a support bar, wherein said guards are supported by said frame and positioned such that said tines extend between each said blade.

22. The apparatus of claim 12 wherein said blades are equally spaced along said shafts and mounted on said shafts at a distance of 0.0625 to 1 inches from each other.

23. A method for the production of dried food pieces comprising the steps of:
a) Introducing said food pieces into a perforator having at least one blade wheel;
b) Perforating said food pieces with said blade wheel;
c) Removing said food pieces from said perforator;
d) Immersing said food pieces in an infusion solution; and
e) Dehydrating said food pieces to a moisture content of less than 10%.

24. The method of claim 23 wherein said food pieces are fresh.

25. The method of claim 23 wherein said food pieces are frozen.

26. The method of claim 23 wherein said perforating of step b) comprises forming 0.5 micrometer to 0.25 inch sized holes on the surface of said food pieces.

27. The method of claim 23 wherein said infusion solution comprises a crystalline sugar solution.

28. The method of claim 27 wherein said crystalline sugar solution comprises sucrose.
